(19) United States
(12) Patent Application Publication
(10) Pub. No.: US 2025/0392352 A1
(43) Pub. Date: Dec. 25, 2025

(54) COOPERATIVE RETRANSMISSION METHOD IN OMAMRC SYSTEM

(71) Applicant: Orange, Issy-Les-Moulineaux (FR)

(72) Inventors: Ali AL KHANSA, Chatillon Cedex (FR); Raphaël VISOZ, Chatillon Cedex (FR)

(21) Appl. No.: 18/879,732

(22) PCT Filed: Jun. 23, 2023
(86) PCT No.: PCT/EP2023/067140

§ 371 Date: Dec. 27, 2024

(30) Foreign Application Priority Data
Jun. 28, 2022 (FR) FR2206422

(51) Int. Cl. H04B 7/024; H04B 7/026; H04L 1/06; H04L 1/1809; H04L 1/1812; H04L 1/1829

(52) U.S. Cl. CPC H04B 7/024; H04B 7/026; H04L 1/06; H04L 1/1809; H04L 1/1819; H04L 1/1864

(57) ABSTRACT

A transmission method for an OMAMRC telecommunication system with M sources (s₁, i . . . , s_{M}), optionally L relays and a destination, where M≥2, L≥0. In the method, when a source has not been able to be decoded by the destination, the destination determines an active set of nodes from among all the nodes of the system that have decoded the source, and then organizes a simultaneous retransmission, via the active set, of a message transmitted by the destination.

### CROSS-REFERENCE TO RELATED APPLICATIONS

This application is filed under 35 U.S.C. § 371 as the U.S. National Phase of Application No. PCT/EP2023/067140 entitled “COOPERATIVE RETRANSMISSION METHOD IN OMAMRC SYSTEM” and filed Jun. 23, 2023, and which claims priority to FR 2206422 filed Jun. 28, 2022, each of which is incorporated by reference in its entirety.

### BACKGROUND

### Field

The present development relates to the domain of digital communications. Within this field, the development relates more particularly to the transmission of coded data between at least two sources and one destination with relaying by nodes which can be relays or sources.

It is understood that a relay does not have any message to transmit. A relay is a node dedicated to relaying messages from sources, whereas a source has its own message to transmit and can also, in some cases, relay the messages from the other sources, (in this case, the source is referred to as cooperative).

There are many different relaying techniques: amplify and forward, decode and forward, compress-and-forward, non-orthogonal amplify and forward, dynamic decode and forward, etc.

The development applies in particular, but not exclusively, to data transmission via mobile networks, for example for real-time applications, or for example, via sensor networks.

Such a sensor network is a multi-user network, comprising several sources, several relays and one destination that can use an orthogonal multiple-access scheme of the transmission channel between the sources and the destination, known as OMAMRC (“Orthogonal Multiple-Access Multiple-Relay Channel”).

According to this scheme, orthogonality between the transmissions of the sources and the relays can be achieved by a time multiplexing in the form of disjointed time slots.

### Description of Related Technology

It is known from application WO 2019/162592 published on 29 Aug. 2019 that an OMAMRC telecommunications system that comprises M sources, optionally L relays and one destination, M≥2, L≥0, with an implementation of a time-orthogonal multiple-access scheme of the transmission channel that applies between the nodes taken among the M sources and the L relays. The maximum number of time slots per transmitted frame is M+T_max with M time slots allocated during an first phase to the successive transmission of the M sources and T_used<T_max time slots for more cooperative transmissions allocated during a second phase to one or more nodes selected by the destination according to a selection strategy.

The known OMAMRC transmission system comprises at least two sources. Each of these sources being able to function at different times either exclusively as a source, or as a relaying node. Optionally, the system can further include relays. The node terminology covers both a relay and a source acting as a relaying node or as a source. The system under consideration is such that the sources can themselves be relays. A relay differs from a source in that it has no message of its own to transmit, i.e. it simply retransmits messages from other nodes. Such an OMAMRC transmission system is described in the article S. Cerovic, R. Visoz, L. Madier “Efficient Cooperative HARQ for Multi-Source Multi-Relay Wireless Networks”, IEEE Eleventh International Workshop on Selected Topics in Mobile and Wireless Computing 2018.

The channels between the different nodes of the system are subject to slow fading and white Gaussian noise. The knowledge of all the system's channels (via the CSI: Channel State Information) by the destination is not available. Indeed, the channels between the sources, the channels between the relays, and the channels between the relays and the sources are not directly observable by the destination, and their knowledge by the destination would require an excessive exchange of information between the sources, the relays and the destination. To limit the cost of feedback overhead, only one item of information about channel distribution/statistical distribution (CDI: Channel Distribution Information) of all channels, e.g. the average quality (for example average SNR, average SINR) of all channels, is assumed to be known by the destination in order to determine the rates allocated to the sources.

Channel adaptation is referred to as of the slow type, i.e. before any transmission, the destination allocates initial rates to the sources knowing the distribution of all channels (CDI: Channel Distribution Information). In general, CDI distribution can be traced back based on the knowledge of the average SNR or SINR of each channel of the system.

During the transmissions of frame-formatted messages of the sources, the CSI of the channels is assumed to be constant (slow fading assumption). Bitrate allocation is not supposed to change for several hundred frames, it only changes when the CDI changes.

A method for transmission implemented in such an OMAMRC system comprises three phases, an initial phase and, for each frame to be transmitted, a 1st phase and a 2nd phase. The transmission of a frame is done in two phases, which are optionally preceded by an additional phase referred to as initial phase.

During the initialisation phase, the destination determines an initial bitrate for each source, taking into account the average quality (for example SNR) of each channel of the system.

The destination estimates the quality (for example SNR) of the direct channels: source to destination and relay to destination according to known techniques based on the use of reference signals. The quality of the source-to-source, relay-to-relay and source-to-relay channels is estimated by the sources and the relays by using, for example, the reference signals. The sources and the relays transmit the average qualities of the channels to the destination. This transmission takes place before the initialisation phase. As only the average value of the quality of a channel is taken into account, it is refreshed on a long time scale, i.e. over a time that allows the fast fading of the channel to be averaged out. This time is of the order of the time required to cover several tens of wavelengths of the transmitted signal frequency for a given speed. The initialisation phase occurs, for example, every 200 to 1000 frames. The destination forwards the initial bitrates it has determined to the sources via a feedback path. The initial bitrates remain constant between two occurrences of the initialisation phase.

During the first phase, the M sources successively transmit their message during the M time slots, using respectively modulation and coding schemes determined from the initial bitrates. During this phase, the number N_1 of channel uses (i.e. resource elements according to 3GPP terminology) is fixed and identical for each of the sources.

During the second phase, messages from the sources are transmitted co-operatively by the relays and/or by the sources. This phase lasts for a maximum of [symbol] T [symbol] max time slots. During this phase, the number N2 of channel uses is fixed and identical for each of the selected nodes (source and relay).

During the first phase, the independent sources broadcast their messages in the form of coded information sequences to a single destination. Each source broadcasts its messages at the initial bitrate. The destination communicates its initial bitrate to each source via strictly limited feedback control channels. Thus, during the first phase, each source in turn transmits its respective message, during the time slots each dedicated to one source.

The sources other than the transmitting source, and possibly the relays, of the “Half-Duplex” type receive the successive messages from the sources, decode them and, if selected, generate a message only from the messages from the sources decoded without error.

The selected nodes then access the channel orthogonally in time with one another during the second phase to transmit their generated message to the destination.

The destination can choose which node to transmit at a given time.

Although such a solution makes it possible to maximise the average spectral efficiency (utility metric) within the considered system while respecting an individual quality of service (QoS) per source, it is advisable to try to further improve the decoding performance of a given source.

The present development meets this objective.

### SUMMARY

To this end, the purpose of the present development is a transmission method intended for an OMAMRC telecommunications system with N nodes and a destination (d), the N nodes comprising M sources (s₁, . . . , s_{M}) and optionally L relays (r₁, . . . , r_{L}) with M≥2, L≥0 comprising a first phase during which the destination receives first redundancies (RV0) of messages transmitted successively by the M sources, the message of a source having been encoded before transmission by an incremental redundancy type encoding comprising several redundancies and a second phase comprising the following steps implemented by the destination (d):
broadcasting a control message identifying one or more sources for which it has not decoded said transmitted message without error, referred to as undecoded sources,
receiving at least one identifier from at least one source (sᵢ) not decoded by the destination transmitted by a first set of nodes comprising at least one node, taken from among the N nodes, having decoded without error said message from a source sᵢ,
determination, from among the nodes of the first set, of a second set of nodes, referred to as the active set (Âᵢ), associated with the source (sᵢ),
transmission of a request for retransmission of said message from the source (sᵢ) to the nodes of the active set (Âᵢ), and
reception of the same second redundancy of the message from the source (sᵢ) transmitted simultaneously by at least two nodes of the active set (Âᵢ) in the same time slot.

Such a method enables several nodes to simultaneously transmit the same redundancy for the same message from the same source in the same time slot.

Knowing that each node in the system has its own independent power budget, the redundancy thus obtained improves the unprocessed decoding performance of a source sᵢ by proposing that some nodes in the system, hereafter referred to as active nodes, that decoded without error a message transmitted by the source sᵢ according to a first redundancy simultaneously retransmit a second redundancy of this message i.e. using the same channel use. These active nodes form what are referred to as an active set.

Thus, the equivalent transmission power for the source sᵢ is multiplied by the number of active nodes in the system that have decoded without error a message transmitted by the source sᵢ and are participating in the retransmission. The first and second redundancies may be identical, for example when a repeating code is used, or may not and may or may not include systematic bits.

In this method, it is specified that the first redundancy is a codeword. The fact that the first redundancy is a codeword makes it possible to trace back to the transmitted message because there is a unique correspondence between the codeword and the message, which requires a coding efficiency of less than or equal to 1.

By avoiding systematically requesting all the nodes in the system, retransmission efficiency is improved. Thus, for example, nodes whose transmission has a limited power gain because their respective transmission channels are of low power are not asked to retransmit the message transmitted by the source sᵢ even if it has been decoded without error by these nodes.

By avoiding activating certain nodes for the retransmission in question, it is then possible to limit the formation of interference. Finally, the energy consumption of the network is reduced, because the nodes that do not provide any real performance gains are not requested.

In one example, determining the active set (Âᵢ) comprises for at least one subset (Âᵢ) of nodes taken from the first set of nodes:
determining a utility metric as a function of the size of said subset (Âᵢ) and the quality of a channel established between the source sᵢ and the destination (d) via the nodes of the subset (Âᵢ),
determining, from among the subsets of nodes taken from the first set of nodes, the subset (Âᵢ) whose determined utility metric is the largest as the active set (Âᵢ).

Here, the constitution of the active set is achieved by seeking to maximise a utility metric, so as to find a compromise between the number of simultaneously active nodes (energy efficiency) and the gain in performance (spectral efficiency). The overall efficiency of the method is improved, without any degradation in the retransmission quality.

In one example, determining the utility metric of a subset (Aᵢ) comprises
determining an item of mutual information [symbol] (SNR_{A}_{ᵢ}) representative of the quality of a channel established between the source sᵢ and the destination via the nodes of the subset (Aᵢ), referred to as mutual information relating to the subset (Aᵢ),
the utility metric being a function of said mutual information thus determined.

In this case, the quality of the channel established between the source and destination via nodes in the subset is represented by the mutual information relating to the channel established between the source and destination via nodes in the subset.

In one example, the utility metric of a subset is proportional to the mutual information relative to that subset.

In one example, the utility metric of a subset (Aᵢ) is inversely proportional to an increasing function of the size of said subset (Aᵢ), said increasing function presenting a logarithmic growth.

In this example, the scenario, referred to as the reference scenario, corresponding to equal fading for all the links between the sources belonging to (Aᵢ) and the destination (d) is considered. In this case, the power received at the destination is proportional to the cardinality of the subset (Aᵢ). This makes it possible to obtain an approximation of the asymptotic behaviour of the mutual information relative to the subset (Aᵢ).

Here, the growth in mutual information is weighted by a denominator whose growth is logarithmic. The choice of a growth quotient that is at least logarithmic stems from the fact that mutual information is a quantity that grows logarithmically at the asymptote, i.e. when the cardinal of the active set becomes very large. This choice of denominator, of logarithmic growth, offsets this logarithmic growth at the asymptote. The presence of such a logarithmic growth denominator makes it possible to determine a smaller active set than if the utility metric depended solely on the mutual information.

The denominator can grow logarithmically or faster than logarithmically. More specifically, in a power-limited regime (or low signal-to-noise ratio (SNR) regime), mutual information shows linear growth (with respect to received power, i.e. with respect to the size of the subset whose utility metric is calculated for the reference scenario). In a band-limited regime (or high SNR regime), mutual information increases logarithmically. Thus, the addition of an extra active node to the subset is only permitted if it contributes to at least a logarithmic increase in spectral efficiency given by the value of mutual information in number of bits per “channel use” or bits per second and per hertz (at least the gain of the band-limited or high SNR regime).

In addition, the discrete nature of the channel inputs, taken into account in the calculation of the mutual information, implies that the mutual information is capped by the number of bits q carried by the modulation. In fact, increasing the power (and therefore the size of the subset whose metric is being determined) asymptotically (i.e. when the size of this subset becomes very large) only leads to negligible gains in spectral efficiency. In other words, adding a node to this large-cardinal subset only increases the mutual information by a small amount, since this mutual information is increased by q, and the large-cardinal subset already has an item of mutual information close to q. The potential increase in mutual information then becomes negligible compared to the logarithmic growth of the denominator. The active set thus determined (as optimal in the sense of the metric among the sets for which the metric is calculated) is of reduced size, compared with the first set comprising all the nodes.

In one example, the method comprises calculating the utility metric M(Aᵢ) is performed for all subsets Aᵢ taken from the first set of nodes.

This determination scheme of an active set is referred to as exhaustive. Here, the destination determines the utility metric of all the subsets in the set, before determining the best subset in the sense of the utility metric. This makes it possible to find the optimal active set for the utility metric.

In one example, the method further comprises constructing a subset (Aᵢ) initially equal to the empty set, said construction comprising at least one iteration of the following steps:
determining a node (j) outside the subset (Aᵢ) with the highest signal-to-noise ratio (SNR),
if adding this node (j) to the subset (Aᵢ) improves the utility metric of the subset (Aᵢ), adding the node (j) to the subset (Aᵢ) at the last iteration, the subset (Aᵢ) thus constructed being the active set (Âᵢ).

The determination scheme in this example of determining an active set is heuristic. In other words, it is an approximation compared to the exhaustive scheme described above. This heuristic scheme is considerably faster to execute, as the number of nodes that can potentially help increases.

In addition, this scheme is optimal in a case referred to as equal gain combining, where all the relay nodes know the CSI of their channel with the destination. Each of these nodes can then know the phase of its channel with the destination, and compensate for this phase. This allows the destination to receive all messages at the same time. The combination of these redundancies is then coherent. In this case, the best mutual information for a given number of active relay nodes is that linked to the set of N relay nodes having the best SNRs (i.e. the best channel qualities with the destination). According to another example, the method further comprises:
determining, for at least one source (sᵢ) not decoded by the destination, of an associated set (Hᵢ) comprising the nodes having decoded without error the message transmitted by said source not decoded by the destination, and determining the mutual information [symbol] (SNR_{H}_{ᵢ}) relative to said associated set (Hᵢ), and
determining, from the at least one undecoded source, the source whose associated set has the highest relative mutual information, and
determining the active set of said source thus determined,
the active set of each of said at least one undecoded source being equal to said active set thus determined.

The scheme in this example is heuristic, and sub-optimal, compared with an exhaustive diagram, but quicker to compute. Rather than determining the active set for each source taken in isolation, the destination first determines the source with the best channel established with the destination via the nodes in its set Hᵢ, assuming retransmission via the nodes in this set. The destination then searches for the best subset of the set Hᵢ, and uses this subset as the active set for all the sources.

The development also relates to a system comprising M sources (s₁, . . . , s_{M}), L relays (r₁, . . . , r_{L}) and a destination (d), M≥2,L≥0 for implementing a transmission method as described above.

The purpose of the development is also a computer program product comprising program code instructions for implementing a method according to the development, as described previously, when it is executed by a processor.

The purpose of the development is also a computer-readable storage medium on which is saved a computer program comprising program code instructions for implementing the steps of a method according to the development as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the method of the above-mentioned development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1 shows an embodiment of the development described in the context of an OMAMRC system,

FIG. 2 shows a transmission cycle of a frame,

FIG. 3 shows the various stages of the transmission method described in the development implemented by the system of FIG. 1,

FIG. 4 shows a circular buffer used to select a redundancy of the message to be transmitted,

FIG. 5 shows step E5 of the method shown in FIG. 3,

FIG. 6 shows a first embodiment of step E50 of step E5 shown in FIG. 5,

FIG. 7 shows a second embodiment of step E50 of step E5 shown in FIG. 5,

FIG. 8 shows a destination belonging to an OMAMRC telecommunication system with M sources, optionally L relays and a destination, M≥2,L≥0 according to an embodiment of the development.

### DETAILED DESCRIPTION OF CERTAIN ILLUSTRATIVE EMBODIMENTS

### General Principle

OMAMRC System with Redundancy

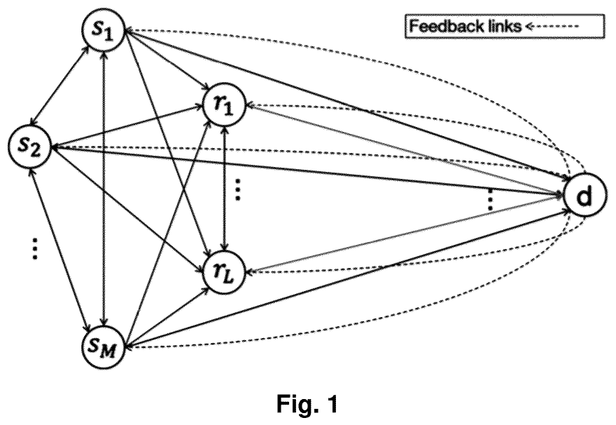

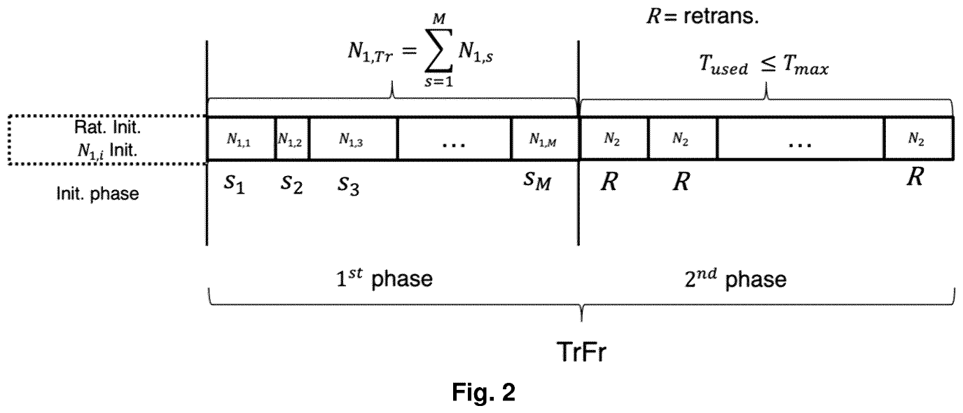

In relation to [FIG. 1], an embodiment of the development described in the context of an OMAMRC system in support of the diagram in [FIG. 2] which illustrates a transmission cycle of a frame is presented.

This system includes M sources belonging to the set of sources [symbol] ={s₁, . . . , s_{M}}, L relays belonging to the set of relays [symbol] ={r₁, . . . , r_{L}} and one destination d. By convention, it is assumed that sᵢ=i∀i∈{1, . . . , M} and rᵢ=M+i∀i∈{1, . . . , L}, in other words, a source can be conflated with its index, and a relay with its index (shifted by a value M, the number of sources).

Every source in the set [symbol] communicates with the single destination d with the help of the other sources (user cooperation) and the relays that cooperate.

As a simplification of the description, the following assumptions are then made regarding the OMAMRC system:
1. the sources, the relays and the destination are equipped with a single transmitting antenna;
2. the sources and the relays are equipped with a single reception antenna;
3. the destination is equipped with N_{R} reception antennas;
4. the sources, the relays and the destination are perfectly synchronised;
5. the sources are statistically independent (there is no correlation between them);
6. all nodes transmit with the same power;
7. a CRC code assumed to be included in the Kₛ information bits corresponding to the message of each sources determine whether or not this message was correctly decoded;
8. the channels between the different nodes suffer from additive noise and fading. The fading gains are fixed during the transmission of a frame for a maximum duration of M+Tₘₐₓ time slots, but may change independently from frame to frame. Tₘₐₓ≥1 is a parameter of the system;
9. the instantaneous quality of the channel/direct link in reception (CSIR Channel State Information at Receiver) is available at the destination, sources and relays;
10. the returns are error-free (no errors on the control signals).

Nodes include relays and sources which can behave like a relay when they are not transmitting their own message.

The nodes, M sources and L relays access the transmission channel according to a multiple access scheme orthogonal in time which enables them to listen to the transmissions of the other nodes without interference. The nodes operate in a half-duplex mode.

The following notations are used:
Hᵢ is the set of nodes a that have decoded without error the message uᵢ transmitted by the source sᵢ,
Âᵢ⊂Hᵢ a subset of the transmitting active nodes selected by the destination for use of channel k
x_{a,k}∈ [symbol] is the symbol coded for use on channel k transmitted by the node a∈ [symbol] ∪ [symbol] ,
y_{a,b,k} is the signal received at the node b∈ [symbol] ∪ [symbol] ∪{d}\{a} of the channel k corresponding to a signal transmitted by the node a∈ [symbol] ∪ [symbol] ,
yₛ_{ᵢ}_{b,k} is the signal received at the node b∈ [symbol] ∪ [symbol] ∪{d}\Âᵢ of the channel k corresponding to the signals transmitted by the nodes a∈Âᵢ,
γ_{a,b} is the average signal-to-noise ratio (SNR) which takes into account the effects of path-loss and shadowing,
   h_{a,b} is the channel fading gain, which follows a symmetrical circular complex Gaussian distribution with zero mean and variance γ_{a,b} (the received power is proportional to the transmitted power), the gains are independent of each other,
   n_{a,b,k} or nₛ_{ᵢ}_{b,k} are samples of a white Gaussian noise (AWGN) distributed in an identical and independent manner that follow a complex Gaussian distribution of circular symmetry with zero mean and unitary variance.

Rₛ is a variable representing the initial bitrate of the source s. Rₛ which can take its values in the finite set {R̅₁, . . . , R̅ₙ_{_{MCS}}}. Similarly, αₛ is a variable representing the ratio N₂/N_{1,s} and can take its values in a finite set A=\overline{{α}₁, . . . , α̅_{|A|}}.

The signal received at the node b∈ [symbol] ∪ [symbol] ∪{d}\{a} of the channel k corresponding to the signal transmitted by the node a∈ [symbol] during the first phase can be written as:

$${y}_{a , b , k} = {h}_{a , b} {x}_{a , k} + {n}_{a , b , k} \qquad ( 1 )$$

The signal received at the node b∈ [symbol] ∪ [symbol] ∪{d}\Âᵢ of the channel k corresponding to the signals transmitted by the nodes belonging to the set Âᵢ during the second phase can be written as:

$${y}_{{s}_{i} , b , k} = ( {\sum }_{a ∈ {\hat{A}}_{i}} {h}_{a , b} {e}^{- j {φ}_{a , d}} ) {x}_{k} + {n}_{{s}_{i} b , k} \qquad ( 2 )$$

where xₖ=x_{a,k}∀a∈Âᵢ, i.e. the same version of redundancy on the message sᵢ is transmitted by all the nodes a∈Âᵢ and Pφ_{a,d} is a phase correction term with respect to the channel h_{a,d} with j²=−1. For the destination node, the received signal is written as

$${y}_{{s}_{i} , d , k} = ( {\sum }_{a ∈ {\hat{A}}_{i}} {h}_{a , d} {e}^{- j {φ}_{a , d}} ) {x}_{k} + {n}_{{s}_{i} , d , k} = {h}_{eq {\hat{A}}_{{i}^{x} k}} + {n}_{{s}_{i} , d , k}$$

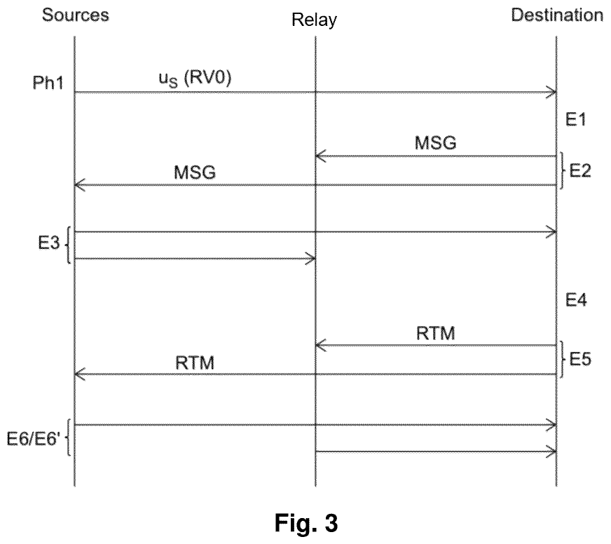

FIG. 3 shows the various stages of the transmission method covered by the development implemented by the system described above.

During an initial phase Ph1 of M time slots, each source s∈ [symbol] transmits a coded message using a code enabling retransmissions of the incremental redundancy type which transforms the message of length L_{M} into a coded sequence of length L_{C}=L_{M}/R₀>L_{M}. The coded sequence includes a first redundancy RV0 which is a codeword transmitted during N_{1,s} uses of the channel, k∈{1, . . . , N_{1,s}}, the number N_{1,s} of uses of the channel dependent on the source s.

By using reference signals (pilot symbols, SRS signals from 3GPP LTE, etc.), the destination can determine the gains (CSI Channel State Information) of the direct channels: h_{dir}={hₛ_{₁}_{,d}, . . . , hₛ_{_{M}}_{,d}, . . . , hᵣ_{_{L}}_{,d}}, i.e. source-to-destination and relay-to-destination channels, and can therefore deduce the average SNRs of these channels.

However, the gains of channels between sources, channels between relays and channels between sources and relays are not known to the destination. Only sources and relays can estimate a metric for these channels by using reference signals in a similar way to that used for direct channels. Given the fact that the statistics of the channels are assumed to be constant between two initialisation phases, the transmission of metrics to the destination d by the sources and relays only occurs at the same frequency as the initialisation phase. The channel statistic for each channel is assumed to follow a centred circular complex Gaussian distribution and the statistics are independent between channels. It is therefore sufficient to consider only the average SNR as a measure of the statistic of a channel.

The sources and the relays therefore forward to the destination metrics representative of the average SNRs of the channels they can observe.

The destination thus knows the average SNR of each channel.

### First Transmission Phase

During an initial phase of link adaptation (not shown in the figures) which precedes the transmission of several frames, the destination transmits for each source s a value representative (index, MCS, bitrate, etc.) of an initial bitrate R̅ᵢ and a value α̅ᵢ.

Each of the initial bitrates unambiguously determines an initial modulation and coding scheme (MCS) or, vice versa, each initial MCS determines an initial bitrate.

The forwarding of initial bitrates R̅ᵢ and reports α̅ᵢ is transmitted via strictly limited feedback control channels.

Each source transmits its framed messages to the destination using the other sources and relays.

A frame occupies time slots when transmitting the M messages of the respectively M sources. The transmission of a frame (which defines a transmission cycle) takes place over M+T_{used} time slots: M slots for the first phase with respective capacities, N_{1,i} channel uses for each source i,T_{used} slots for a second phase which will be described later in this document.

During the first phase, each source s∈ [symbol] transmits a coded message uₛ of Kₛ information bits uₛ∈ [symbol] ₂^{K}^{ₛ}, [symbol] ₂ being the two-element Galois field. The message uₛ includes a code of the CRC type which is used to check the integrity of the message uₛ. The message uₛ is coded according to the initial MCS. Given that the initial MCSs may differ between sources, the lengths of the coded messages may differ between sources.

The coding applied uses an incremental redundancy code which can be based, for example but not exclusively, on existing codes such as convolutional codes, turbo codes, LDPC, etc.

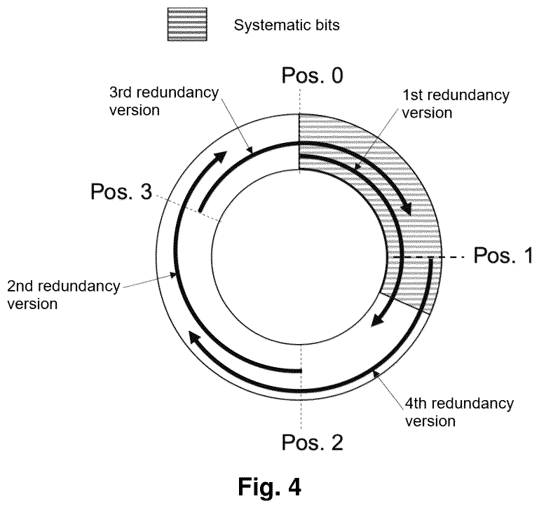

The principle of this type of code is as follows: a message transmitted by each source is encoded into a coded sequence of bits (the message may be segmented into several independently encoded sub-blocks if the message is too long) by a very low-efficiency mothercode (⅓ for example). The coded bits are then placed in a circular buffer shown in FIG. 4 having several reading start positions Pos. 0, Pos. 1, Pos. 2 and Pos. 3. Such a circular buffer contains the coded bits of a message from a source coded by a (possibly) systematic low-efficiency mothercode and making it possible to select a particular redundancy of the message to be transmitted according to a reading start position in the circular buffer.

These reading start indexes Pos. 0, Pos. 1, Pos. 2 and Pos. 3 correspond to different redundancy blocks/versions. In this example, there are four possible versions of redundancy. For each redundancy block/version, a node will read the number of coded bits to be sent, corresponding to the number of channel uses available for a given modulation and message size, from the corresponding redundancy position by moving in the circular buffer in the direction of the initial fill. Whether or not the incremental redundancy code is of the systematic type, it is such that the first version of the redundancy block/version can be decoded independently of the other blocks/versions.

Thus, in the first phase, the M sources successively transmit the first redundancy RV0 of their respective messages uₛ coded during the M slots with respectively modulation and coding schemes determined from the initial bitrate values.

Each transmitted message us corresponds to a source s∈ [symbol] , a correctly decoded message is assimilated to the corresponding source by abuse of notation.

When a source is transmitting, the other sources and relays listen and try to decode the messages received at the end of each time slot.

### Second Transmission Phase

A second transmission phase comprises steps E1 to E6. In a first step E1, the destination determines whether or not the received messages have been successfully decoded using the CRC.

In this second phase, a given node, source or relay, can indeed act as a relay by cooperating with the sources to help the destination correctly decode the messages from all the sources. This given node transmits (i.e. cooperates by transmitting) a redundancy version of a message from a source that it has correctly decoded. The second phase comprises a maximum of Tₘₐₓ time slots called rounds. Each round t∈{1, . . . , Tₘₐₓ} has a capacity of N₂ channel uses.

If all the sources are decoded correctly, the destination broadcasts a message of the ACK type. In this case, a transmission cycle of a new frame begins with the clearing of the memories of the relays and destination and with the transmission by the sources of new messages.

If the decoding of at least one source is erroneous, a retransmission method comprising steps E2 to E6 is implemented. In a step E2, the destination broadcasts one message MSG identifying the source or sources for which it has not decoded without error the transmitted message. Such sources are referred as decoded sources. The message MSG can be sent to relays, to sources that can be used as relays, or to both. This message is a control message.

Such a message broadcast by the destination includes, in a first implementation, identifiers of the sources for which the destination has decoded without error the transmitted message. In this first implementation, the nodes intercepting the broadcast message determine the sources for which the destination has not decoded without error the transmitted message.

In a second implementation, the message broadcast by the destination includes identifiers of the sources for which the destination has not decoded without error the transmitted message. In this second implementation, the nodes intercepting the broadcast message immediately know the identity of the sources for which the destination has not decoded without error the transmitted message.

The destination informs the nodes using a limited feedback control channel to transmit the message MSG. This message MSG is based on the decoding result of the messages received by the destination. The destination thus controls the transmission of the nodes using this message MSG, which improves spectral efficiency and reliability by increasing the probability of all sources being decoded by the destination.

On receiving a message MSG, a node a∈ [symbol] ∪ [symbol] which has correctly decoded the message uₛ from one or more sources not correctly decoded by the destination at the end of the previous time slot (round) noted [symbol] _{a,t-1} transmits to the destination, in a step E3, the identifier of these sources.

By convention, [symbol] _{b,t}⊆ [symbol] is the set of messages (or sources) correctly decoded by the node b∈ [symbol] ∪ [symbol] ∪{d} at the end of the time slot t (round t), t∈{0, . . . , Tₘₐₓ}. The end of the time slot (round) t=0 corresponds to the end of the first phase. The number of time slots used during the second phase T_{used}={1, . . . , Tₘₐₓ} depends on the success of the decoding at the destination.

During a step E4, the destination selects a source sᵢ for which a retransmission is required. Such a source sᵢ is selected from the set of sources correctly decoded by one or more nodes ∈ [symbol] ∪ [symbol] , at the end of the previous time slot t (round t), t∈{0, . . . , Tₘₐₓ}.

Thus, rather than leaving the choice of a message to retransmit to the nodes that have decoded without error a message transmitted by a source, the destination imposes the choice of message and therefore of the source for which a retransmission is required.

In an initial implementation, the source sᵢ selected by the destination is the source for which a signal-to-noise ratio SNRᵢ associated with a composite transmission channel,

$$( {\sum }_{a ∈ {H}_{i}} {h}_{a , d} {e}^{- j {φ}_{a , d}} )$$

with φ_{a,d}=0∀a∈Hᵢ, established directly between each of the nodes that decoded without error the transmitted message uᵢ by the source sᵢ and the destination, is the highest.

By choosing the source for which the composite transmission channel has a high signal-to-noise ratio, the destination increases its chances of decoding without error the message uᵢ, when it is retransmitted.

In a step E5, once the destination d has selected the source sᵢ for which a retransmission is required, the destination d:
determines, from among the sources and relays of Hᵢ, a subset, hereinafter referred to as active set Âᵢ associated with the source sᵢ, of nodes, referred to as active nodes, intended to help retransmit the message transmitted by the source sᵢ, and
transmits a retransmission request RTM to the active nodes belonging to the active set (Âᵢ). This retransmission request RTM includes a source identifier sᵢ.

In step E6, a redundancy of the message uᵢ transmitted by the source sᵢ, is retransmitted.

On receiving the retransmission request from the nodes of the active set, each active node, in step E6, transmits the same redundancy, modulated by a phase factor e^{-jϕ}^{_{a,d}}=h_{a,d}* /|h_{a,d}| with j²=−1. Here, the factor h_{a,d} represents the transmission channel established between the node a and the destination d, h_{a,d}*/|h_{a,d}| corresponds to the conjugate h_{a,d}* of the transmission channel h_{a,d} established between the node a and the destination d divided by its norm |h_{a,d}| in the same time interval. The factor ϕ_{a,d} represents the phase of the transmission channel h_{a,d} established between this active node and the destination d. The transmission power of each node in this step E6 is denoted by P.

In a first implementation of this step E6, none of the active nodes is aware of the phase ϕ_{a,d}. The combination at the destination of retransmissions by these active nodes is thus not coherent. The signal-to-noise ratio SNRᵢ of the composite transmission channel established between the source and destination via the nodes of the active set is expressed as:

$$S N {R}_{i} = \frac{P {\vert {h}_{eq , {\hat{A}}_{i}} \vert}^{2}}{{N}_{0}} with {h}_{eq , {\hat{A}}_{i}} = {\sum }_{a ∈ {\hat{A}}_{i}} {h}_{a , d}$$

Where N₀ is the spectral density of noise and interference and Âᵢ is the active set.

In a second implementation of this step E6, each of the active nodes is aware of the phase ϕ_{a,d}. The combination at the destination of retransmissions by these active nodes is thus coherent, because each node can compensate for this phase by a factor of e^{-jϕ}^{_{a,d}} so that all the messages arrive at the destination at the same time, ensuring that the combination of these messages is coherent. The signal-to-noise ratio SNRᵢ of the composite transmission channel is therefore expressed as:

$$S N {R}_{i} = \frac{P {\vert {h}_{eq , {\hat{A}}_{i}} \vert}^{2}}{{N}_{0}} with {h}_{eq , {\hat{A}}_{i}} = {\sum }_{a ∈ {\hat{A}}_{i}} \vert {h}_{a , d} \vert$$

More specifically, this second implementation of the transmission is carried out in such a way that all the redundancies transmitted by the active nodes are received at the same time by the destination in a coherent manner. Thus, the composite channel h_{eq,Â}_{ᵢ} in this case is expressed according to the following formula:

$${h}_{eq , {\hat{A}}_{i}} = ( {\sum }_{a ∈ {\hat{A}}_{i}} {h}_{a , d} {e}^{- j {φ}_{a , d}} ) = {\sum }_{a ∈ {\hat{A}}_{i}} \vert {h}_{a , d} \vert$$

Such a transmission mode, referred to as equal gain combining, makes it possible to obtain, on the destination side, a coherent combination of all the signals transmitted by the active nodes.

The redundancy of the message transmitted by each active node is the same. Such a redundancy may be the RV0 redundancy transmitted during the first PH1 phase or any other message redundancy uᵢ. The transmission of redundancies can follow a predefined order of circular buffer read start positions for a message from a repeating source. For example, with reference to FIG. 4 for 4 redundancy blocks/versions, a systematic LDPC code and N_{1,s}=N₂∀s∈ [symbol] the order can be Pos. 0, Pos. 2, Pos. 3, Pos. 1 and so on with RV0 and RV3 the redundancy versions associated with Pos. 0 and Pos. 3 which can be decoded independently of other blocks/versions (each second transmission is self-decodable).

In a third implementation of step E6, the system comprises a first group Dᵢ of active nodes being aware of the phase ϕ_{a,d} and a second group Eᵢ of active nodes that do not know this phase ϕ_{a,d} with Âᵢ=Dᵢ∪Eᵢ. In this third implementation, the signal-to-noise ratio SNRᵢ of the composite transmission channel is expressed as:

$$S N {R}_{i} = \frac{P {\vert {h}_{eq , {\hat{A}}_{i}} \vert}^{2}}{{N}_{0}} {h}_{eq , {\hat{A}}_{i}} = {\sum }_{a ∈ {D}_{i}} \vert {h}_{a , d} \vert + {\sum }_{a ∈ {E}_{i}} {h}_{a , d}$$

Upon reception of the retransmission request, each node belonging to the first group Dᵢ transmits, in a step E6′, the same redundancy of the message transmitted by the source s, modulated by a phase factor e^{-jϕ}^{_{a,d}}=h_{a,d}* /|h_{a,d}| with j²=−1, and each active node belonging to the second group Eᵢ transmits the same redundancy of said message transmitted by the source sᵢ without phase modulation in the same time slot so that all these redundancies transmitted by these nodes are received at the same time by the destination d.

This is the case, for example, in a transitional period during which the destination d has not yet been able to determine the item of information relating to the phase factors e^{-jϕ}^{_{a,d}} for all the active nodes. Over time, the destination d will be able to provide such an item of information to all the nodes in the system, further improving transmission quality.

In this third implementation as well as for the other implementations, the redundancy of the message transmitted by each node that decoded without error the message uᵢ transmitted by the source sᵢ is the same for each of these nodes. Such redundancy may be the RV0 redundancy transmitted during the first PH1 phase or any other redundancy in the message uᵢ. The transmission of redundancies can follow a predefined order of reading start positions of the circular buffer for a same message from a source that may need to be retransmitted several times.

For example, with reference to FIG. 4 for 4 redundancy blocks/version, a systematic LDPC code and N_{1,s}=N₂, ∀s∈ [symbol] the order can be Pos. 0, Pos. 2, Pos. 3, Pos. 1 and so on with RV0 and RV3 the redundancy versions associated with Pos. 0 and Pos. 3 which can be decoded independently of other blocks/versions (each second transmission is self-decodable).

### Determining an Active Set

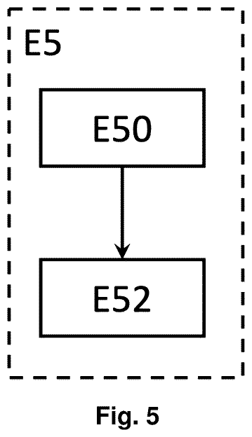

Reference is now made to FIG. 5, which shows step E5 in more detail, in which the destination d determines an active set Aᵢ and then requests to retransmit a redundancy of the message a that it was unable to decode without error to the active nodes constituting this active set Âᵢ. For the sake of readability, a message a, the source sᵢ that sent it (and for which the destination is seeking a redundancy) and the index i of this source will be conflated.

Step E5 comprises a step E50 of determining such an active set Âᵢ, and a step E52 of transmitting a retransmission request to the active nodes constituting this active set Âᵢ.

The active nodes constituting the active set Âᵢ are determined from among the sources and relays of the system [symbol] ∪ [symbol] . The retransmission request is sent by the destination to the active nodes of the active set Âᵢ.

In one embodiment, the active set Âᵢ is determined by having recourse to a utility metric M:Âᵢ=→F(Aᵢ). The utility metric M(Âᵢ) is determined by the destination for one or more subsets Aᵢ these subsets Aᵢ all being included in the set of sources and relays [symbol] ∪ [symbol] of the system. The destination selects the subset Âᵢ with the highest utility metric M(Aᵢ). In other words, the destination selects the subset Aᵢ that is most advantageous in terms of this utility metric M.

More specifically, during step E50, the destination determines a utility metric M(Aᵢ) for at least a subset Aᵢ of given nodes. In this example, the utility metric M is a function of the size |Aᵢ| of said subset Aᵢand the quality of the channel established between the source sᵢ and the destination d via the nodes belonging to the subset Aᵢ.

The subset Aᵢ with the highest determined utility metric is then selected as the active set Âᵢ.

In this case, it is then possible to determine which nodes make up the active set Âᵢ from the nodes belonging to the set Hᵢ (previously obtained or determined by the destination). This de facto excludes nodes that cannot help the destination receive a redundant message from the source (i.e. contribute to retransmitting a redundant message). In other words, the set Hᵢ includes the nodes j of [symbol] ∪ [symbol] \{sᵢ} such that S_{j,t-1}∩S̅_{D,t-1}≠∅, where S_{j,t-1} represents the nodes which were able to decode a message from the source at the previous frame t−1, and S̅_{D,t-1} represents the complement (in [symbol] ∪ [symbol] \{sᵢ}) of the set S_{D,t-1} of nodes whose destination was able to decode without error at the previous frame t−1.

### Mutual Information

In one embodiment, the utility metric M of a given subset Aᵢ is proportional to a discrete input item of mutual information between source and destination d knowing the composite transmission channel h_{eq,A}_{ᵢ} established between the source and the destination via the nodes of the subset Aᵢ. Thus, mutual information is a quantity representative of the quality of the channel established between the source sᵢ and the destination d via the nodes of the subset Aᵢ.

Mutual information can be expressed as the difference between the entropy H(xᵢ) of a message xᵢ transmitted by the source sᵢ and the conditional entropy H(xᵢ|yᵢ) of said message xᵢ transmitted by the source sᵢ knowing the message yᵢ received by the destination d.

Mutual information between the input x_{S}_{ᵢ} and the output y_{D} knowing h_{eq,A}_{ᵢ} is denoted I(y_{D}; x_{S}_{ᵢ}). As

$$\frac{{y}_{D}}{{h}_{eq , {A}_{i}}}$$

is a sufficient statistic tor the detection of x_{S}_{ᵢ}, it follows that

$$I ( {y}_{D} ; {x}_{{S}_{i}} ) = I ( {y}_{1} = \frac{{y}_{D}}{{h}_{eq , {A}_{i}}} ; {x}_{{S}_{i}} )$$

As described above, there is I(y₁; x_{S}_{ᵢ})=H(x_{S}_{ᵢ})−H(x_{S}_{ᵢ}|y₁) where H(x) and H(x|y) are respectively the entropy of x and the conditional entropy of x knowing y.

Entropy H(x_{S}_{ᵢ}) given that Pr(x_{S}_{ᵢ}=aᵢ)=p(aᵢ)=1/Q, ∀aᵢ∈ [symbol] ᵢ is expressed (where [symbol] ᵢ is the constellation of the modulation, i.e. the set of symbols potentially transmitted):

$$H ( {x}_{{S}_{i}} ) = - p ( {a}_{i} ) {log}_{2} p ( {a}_{i} ) = - \frac{1}{Q} {log}_{2} ( {2}^{- q} ) = q$$

The conditional entropy H(x_{S}_{ᵢ}|y₁) is expressed as:

$$H ( {x}_{{S}_{i}} \vert {y}_{1} ) = - \int p ( {a}_{i} , {y}_{1} ) {log}_{2} \frac{p ( {a}_{i} , {y}_{1} )}{p ( {y}_{1} )} {dy}_{1} = - \int p ( {y}_{1} \vert {a}_{i} ) {log}_{2} \frac{p ( {y}_{1} , {a}_{i} ) p ( {a}_{i} )}{p ( {y}_{1} \vert {b}_{i} ) p ( {b}_{i} )} {dy}_{1}$$

$$Hence :$$

$$I ( {y}_{1} ; {x}_{{S}_{i}} ) = q - \frac{1}{Q} \int p ( {y}_{1} \vert {a}_{i} ) ( {log}_{2} ( \frac{p ( {y}_{1} \vert {b}_{i} )}{p ( {y}_{1} \vert {a}_{i} )} ) ) {dy}_{1} = q - \frac{1}{Q} {𝔼}_{\{ p ( {y}_{1} \vert {a}_{i} ) \}} ( {log}_{2} ( p ( {y}_{1} \vert {b}_{i} ) ) - {log}_{2} ( p ( {y}_{1} \vert {a}_{i} ) ) )$$

where E_{{p(y}_{₁}_{|a}_{ᵢ})} represents the expectation with respect to the probability distribution p(y₁|aᵢ).

As

$$p ( {y}_{1} \vert {a}_{i} ) = \frac{S N {R}_{{A}_{i}}}{π} e - S N {R}_{{A}_{i}} {\vert ( {y}_{1} - {a}_{i} ) \vert}^{2}$$

is a function of y₁, of aᵢ and of SONRAᵢ=|h_{eq,A}_{ᵢ}|²/2σ², it follows that the mutual information between y₁ and x_{S}_{ᵢ} is a function that depends on [symbol] ᵢ and the SNR associated with the equivalent channel. In other words:

$$I ( {y}_{1} ; {x}_{{S}_{i}} ) = ( S N {R}_{{A}_{i}} )$$

To estimate [symbol] (SNR_{A}_{ᵢ}), it is possible to use an integration method, such as Monte-Carlo, based on L samples y₁^{l}=h_{eq,A}_{ᵢ}aᵢ+nₗ drawn according to the distribution p(y₁|aᵢ):

$$( S N {R}_{{A}_{i}} ) = q - \frac{1}{Q} \frac{1}{L} {\sum }_{l = 1}^{L} ( {log}_{2} ( p ( {y}_{1}^{l} \vert {b}_{i} ) ) - {log}_{2} ( p ( {y}_{1}^{l} \vert {a}_{i} ) ) )$$

The signal-to-noise ratio SNR_{A}_{ᵢ}=P|h_{eq,A}_{ᵢ}|2/N₀ with transmission power P per node does not depend directly on the cardinality of the group of active nodes except for the reference scenario where h_{a,d}=h, ∀a∈Aᵢ. In this case, the addition of an active node makes it possible to aggregate its power, i.e. to have an equivalent reception power increased by P, i.e.

$$S N {R}_{{A}_{i}} = \frac{\vert {A}_{i} \vert P {\vert h \vert}^{2}}{{N}_{0}}$$

The following formula can be used to calculate the utility metric:

$$M ( {A}_{i} ) = ( S N {R}_{{A}_{i}} ) / {K}_{\vert {A}_{i} \vert}$$

Where the denominator K|Aᵢ| is a factor increasing with the cardinal |Aᵢ| of Aᵢ. This reflects the fact that, as the number of nodes integrated into the subset Aᵢ increases, the better the quality of the channel established between the source sᵢ and the destination d (and therefore better mutual information). Consequently, this improvement in mutual information is weighted by a cost in terms of the number of nodes involved in a retransmission.

### Logarithmic Decay

In one embodiment, the denominator K|Aᵢ| has a logarithmic growth. Logarithmic growth means at least logarithmic, i.e. that the growth of the denominator is either logarithmic or faster (linear, quadratic, exponential, etc.).

In this case, the utility metric M(Aᵢ) of a subset Aᵢ is determined according to the following formula:

$$M ( {A}_{i} ) = \frac{( S N {R}_{{A}_{i}} )}{{α}_{\vert {A}_{i} \vert} {log}_{2} ( 1 + \vert {A}_{i} \vert )}$$

Where α|Aᵢ| is a normalisation coefficient, increasing with the cardinal |Aᵢ| of Aᵢ. By increasing, α₁≤ . . . ≤α_{L+M} is meant (which allows a constant coefficient).

Here, the utility metric of a subset Aᵢ is thus inversely proportional to an increasing function of the size of said subset Aᵢ, said increasing function presenting a logarithmic growth.

The choice of a denominator of the type log₂(1+|Aᵢ|) comes from the fact that, in power-limited regimes, mutual information increases linearly with received power, whereas it increases logarithmically in high SNR or band-limited regimes. Thus, transmission by an additional active node (i.e. its integration into a subset by increasing the utility metric) is authorised if it contributes to a logarithmic increase in spectral efficiency. Taking account of the discrete nature of the channel inputs via the mutual information is also important, as the mutual information is capped by the number of bits q carried by the modulation. When the number of nodes included in the active set is very large, increasing the power only leads to negligible gains in spectral efficiency, much less than a logarithmic increase.

In one embodiment, the coefficient α|Aᵢ| is constant irrespective of |Aᵢ|, for example ∀ᵢ, αᵢ=1.

In another embodiment, α|Aᵢ|=n|Aᵢ|, where n is a constant (not necessarily integer) greater than 1. In this case, the denominator thus has an exponential growth.

### Individual Method for Determining the Active Set

The general principle for obtaining the active set during step E50 has already been described.

Various examples of the method for determining the active set are now described.

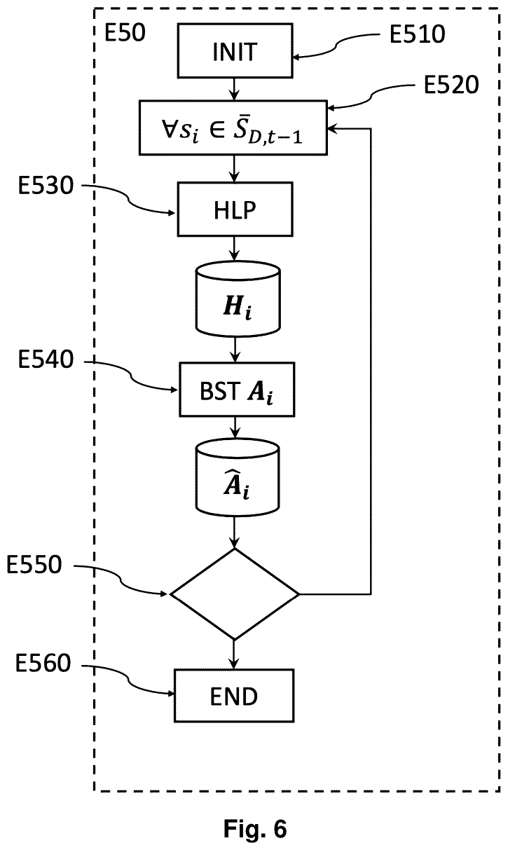

In a first determination method, shown in FIG. 6, the destination determines, during step E50 and for each source sᵢ for which retransmission of a redundancy may be requested by the destination, an active set Âᵢ. This first method is referred to as individual method, i.e. source by source.

The destination initialises the method (E510), by initiating, in a step E520, an iteration loop for each source sᵢ of the set S_{D,t-1} of sources not decoded by the destination. In a step E530, the destination determines the set Hᵢ of a source sᵢ (on which is iterated), i.e. the set of all nodes which can contribute to the retransmission of the message sent by this source sᵢ (i.e. nodes j∈ [symbol] ∪ [symbol] such as S_{j,t-1}∩S̅_{D,T-1}≠∅ in other words, nodes which have decoded the message sent by the source sᵢ). The destination then determines, for this source sᵢ, the active set Âᵢ associated with it during a step E540. In step E550, the destination then checks whether there are any remaining sources for which the corresponding active set Âᵢ must be determined. If this is the case, the destination loops back to step E520, otherwise it ends the method in step E560.

### Exhaustive Determination of the Active Set

In a first embodiment of step E540, referred to as exhaustive determination, step E540 comprises:
the determination of all subsets Aᵢ of the set Hᵢ,
the determination, for each subset Aᵢ, of its corresponding utility metric M(Aᵢ), determination of the subset Aᵢ with the highest utility metric from the set of utility metrics determined as the active set Âᵢ of the source sᵢ.

This method is known as an exhaustive method, because the destination determines an optimal subset in the sense of the utility metric exhaustively, i.e. a metric is calculated for all possible configurations (i.e. all active subsets).

### Heuristic Determination by Decreasing SNR of the Active Set

In a second embodiment of step E540, the destination builds the active set. To do this, step E540 comprises sorting the nodes j making up the set Hᵢ in descending order of SNR,
the construction of a subset Aᵢ initially equal to the empty set,
an iteration on the nodes j constituting the set Hᵢ in descending order of SNR, an iteration loop comprising:
   if adding the node j to the subset Aᵢ improves the utility metric of the subset Aᵢ actually adding this node j to the subset Aᵢ and continue the iteration, otherwise
   stop the iteration and select the subset Aᵢ as the active set Âᵢ for the source sᵢ.

This method of performing step E540 is referred to as determining the active set by decreasing SNR. This determination by decreasing SNR is less complex than the exhaustive determination, while making it possible to determine an active set which is an approximation of the optimal set in the sense of the utility metric M. Furthermore, in the equal gain combining embodiment described above, the active set determined by the descending SNR determination is the optimal set in the sense of the utility metric M.

In such a case, the messages are combined in a coherent (i.e. non-destructive) manner as explained above in point 5.1.3. The equivalent channel is then a function of the gains |h_{a,d}|. So, choosing the relay node with the best gain (i.e. the best SNR) means choosing the optimum active set for all the relay nodes.

Formulated differently, this determination by decreasing SNR can be summarised in that it comprises constructing a subset Aᵢ initially equal to the empty set, said construction comprising at least one iteration of the following steps:
determining the node j not belonging to the subset Aᵢ with the highest signal-to-noise ratio (SNR), if adding this node j to the subset Aᵢ improves the utility metric of the subset Aᵢ, add the node j to the subset Aᵢ, otherwise stop the iteration, the subset Aᵢ thus constructed being the active set Âᵢ.

### Common Method for Determining the Active Set

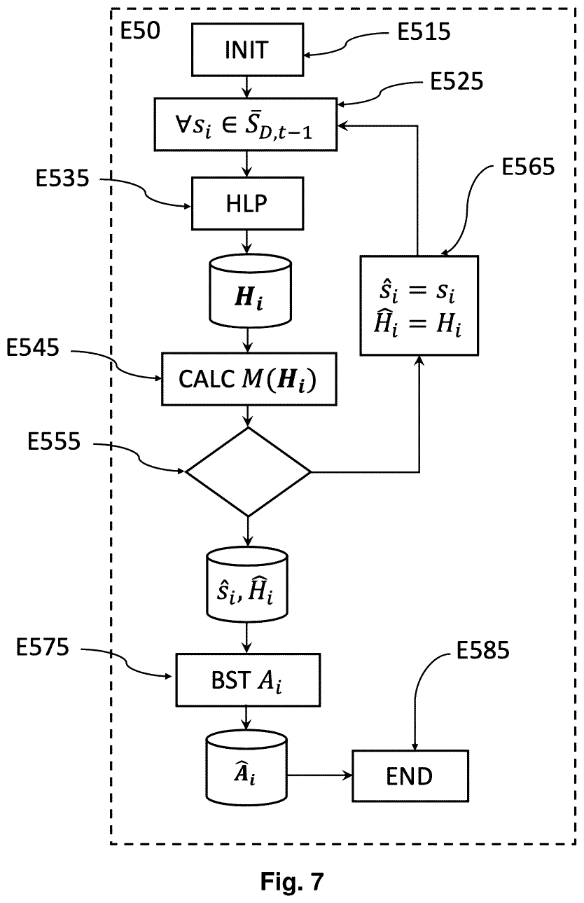

An initial method for determining the active set, source-by-source (or “individual”), has been described. A second method for determining the active set, called the common method and shown in [FIG. 7] is now described.

This common method differs from the source-by-source method in that several steps are shared between the different sources for which a message retransmission using redundancy is requested by the destination.

More specifically, step E50 of this common method determines an active set Âᵢ common to all the sources sᵢ for which a redundancy retransmission is requested by the destination. Step E50 thus includes an initialisation step E515. During this initialisation step, a value I_MAX is set to 0.

In a step E525, the destination starts an iteration loop on the sources sᵢ of the set S̅_{D,t-1} of all the sources not decoded by the destination. For the current source sᵢ of the current iteration, the destination determines in a step E535 its set Hᵢ. The destination then determines the mutual information [symbol] (SNR_{H}_{ᵢ}) relative to a channel established between the source sᵢ and the destination d via the nodes of the set Hᵢ. The destination then determines the mutual information [symbol] (SNR_{H}_{ᵢ}) in a step E545 (i.e. the mutual information between the source sᵢ and the destination d through the nodes constituting the set Hᵢ). In step E555, the destination then compares this mutual information with the value I_MAX which represents the largest value of the mutual information relating to a channel established between the source sᵢ and the destination d via the nodes of the set Hᵢ calculated so far. If [symbol] (SNR_{H}_{ᵢ})>I_MAX, then this means that the set Hᵢ of the current source sᵢ is the set granting the source sᵢ the best mutual information calculated so far, and the destination stores this pair (sᵢ, Hᵢ) in a step E565, then loops back to the beginning of the iteration in step E525, if there are still sources sᵢ on which the destination has not yet iterated.

When all the sources to be processed have been processed, the destination obtains the best source-set pairing (ŝᵢ, Ĥᵢ). From this best pairing (sᵢ, Hᵢ), the destination determines the active set Âᵢ for this source sᵢ in step E575. The destination selects this active set Âᵢ as the active set for the set of sources for which retransmission of a redundancy is requested by the destination, and terminates the common method in a step E585.

Step E575 may comprise an exhaustive determination, as described in section 5.5.1. Alternatively, step E575 may comprise a determination by decreasing SNR as described in section 5.5.2.

In other words, this common determination can be summarised as comprising
determining, for at least one undecoded source sᵢ, an associated set Hi (i.e. the set) comprising the nodes having decoded without error the message transmitted by said source, and determining the mutual information [symbol] (SNR_{H}_{ᵢ}) relative to said associated set Hᵢ, and
determining, from the at least one undecoded source, the source whose associated set has the highest relative mutual information, and determining the active set of said source thus determined,
the active set of each of said at least one undecoded source being equal to said active set thus determined.

### Device

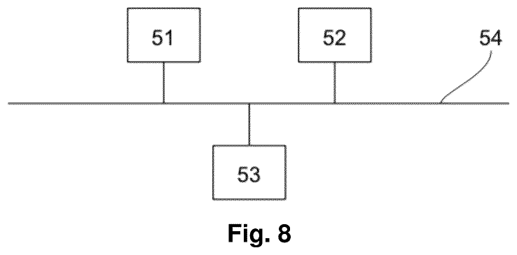

FIG. 8 shows a destination intended for an OMAMRC telecommunication system with M sources, optionally L relays and a destination, M≥2, L≥0 according to an embodiment of the development. Such a destination is able to implement the transmission method according to FIG. 3.

A destination may comprise at least one hardware processor 51, a storage unit 52 and at least one network interface 53 which are connected to each other via a bus 54. Naturally, the components of the destination can be connected by means 35 of a connection other than a bus.

The processor 51 controls the operations of the destination. The storage unit 52 stores at least one program for implementing the method according to one embodiment of the development to be executed by the processor 51, and various data, such as parameters used for calculations performed by the processor 51, intermediate data for calculations performed by the processor 51, etc. The processor 51 may be formed by any known and appropriate hardware or software, or by a combination of hardware and software. For example, the processor 51 can be formed by a dedicated hardware such as a processing circuit, or by a programmable processing unit such as a Central Processing Unit which executes a program stored in a memory thereof.

The storage unit 52 may be formed by any appropriate means capable of storing the program or programs and data in a computer-readable manner. Examples of storage devices 52 include non-transitory computer-readable storage media such as semiconductor memory devices, and magnetic, optical or magneto-optical recording media loaded into a read/write device.

The network interface 53 provides a connection between the destination and the set of nodes j∈ [symbol] ∪ [symbol] .

1. A transmission method intended for an Orthogonal Multiple-Access Multiple-Relay Channel (OMAMRC), telecommunications system with N nodes and a destination, the N nodes comprising M sources (S₁, . . . , S_{M}) and optionally L relays (r₁, . . . , r_{L}), with M≥2, L≥0, comprising a first phase during which the destination receives first redundancies of messages transmitted successively by the M sources, the message of a source having been encoded before transmission by an incremental redundancy type encoding comprising several redundancies and a second phase comprising the following implemented by the destination:
broadcasting a control message identifying one or more sources for which it has not decoded the transmitted message without error, referred to as undecoded sources,
receiving at least one identifier from at least one source sᵢ not decoded by the destination transmitted by a first set of nodes comprising at least one node, taken from among the N nodes, having decoded without error the message from the source sᵢ,
determining, from among the nodes of the first set, of a second set of nodes, referred to as the active set, associated with the source sᵢ,
transmitting of a request for retransmission of said the message from the source sᵢ to the nodes of the active set, and
receiving of the same second redundancy of the message from the source sᵢ transmitted simultaneously by at least two nodes of the active set in the same time slot.

2. The method according to claim 1, such that determining the active set comprises for at least one subset of nodes taken from the first set of nodes:
determining a utility metric as a function of the size of the subset and the quality of a channel established between the source sᵢ and the destination via the nodes of the subset, and
determining, from among the subsets of nodes taken from the first set of nodes, the subset whose determined utility metric is the largest as the active set.

3. The method according to claim 2, such that determining the utility metric of a subset comprises:
determining an item of mutual information [symbol] (SNR_{A}_{ᵢ}) representative of the quality of a channel established between the source sᵢ and the destination via the nodes of the subset, referred to as mutual information relating to the subset,
the utility metric being a function of the item of mutual information thus determined.

4. The method according to claim 3, such that the utility metric of a subset is proportional to the item of mutual information relative to the subset.

5. The method according to claim 3, such that the utility metric of a subset is inversely proportional to an increasing function of the size of the subset, the increasing function presenting a logarithmic growth.

6. The method according to claim 2, such that calculating the utility metric is performed for all subsets taken from the first set of nodes.

7. The method according to of claim 2, such that it further comprises constructing a subset initially equal to the empty set, the construction comprising at least one iteration of the following:
determining a node outside the subset with the highest signal-to-noise ratio,
if adding the node to the subset improves the utility metric of the subset, adding the node to the subset,
at the last iteration, the subset thus constructed being the active set.

8. The method according to claim 2, further comprising:
determining, for at least one source (sᵢ) not decoded by the destination, of an associated set comprising the nodes having decoded without error the message transmitted by the source not decoded by the destination, and determining the mutual information [symbol] (SNR_{H}_{ᵢ}) relative to the associated set, and
determining, from a set of undecoded sources, the source whose associated set has the highest relative mutual information, and
determining the active set of the source thus determined,
the active set of each of the at least one undecoded source being equal to the active set thus determined.

9. A system comprising M sources (s₁, . . . , s_{M}), L relays (r₁, . . . , r_{L}) and a destination, M≥2, L≥0, for implementing the transmission method according to claim 1.

10. Computer A processing circuit comprising a processor and a memory, the memory storing program code instructions of a computer program to execute the transmission method according to claim 1, when the computer program is executed by the processor.
